(19) United States
(12) Patent Application Publication
(10) Pub. No.: US 2009/0131567 A1
(43) Pub. Date: May 21, 2009

(54) Polyether Silyl Aqueous Dispersion

(75) Inventors: Marc Chaussade, Villeurbanne (FR); Michel Feder, Villeurbanne (FR)

Correspondence Address: BUCHANAN, INGERSOLL & ROONEY PC, POST OFFICE BOX 1404, ALEXANDRIA, VA, 22313-1404, US

(73) Assignee: BLUESTAR SILICONES FRANCE SAS, Lyon (FR)

(21) Appl. No.: 11/794,092

(22) PCT Filed: Dec. 23, 2005
(86) PCT No.: PCT/FR05/03269

§ 371 Date: Jun. 11, 2008

(30) Foreign Application Priority Data
Dec. 23, 2004 (FR) 04 13854

(51) Int. Cl. C08K 3/26; C08L 83/05

(52) U.S. Cl. 524/280; 524/588

(57) ABSTRACT

The invention concerns an aqueous dispersion capable of crosslinking by condensation into elastomer by eliminating water in the presence of a polycondensation catalyst, comprising, dispersed in a continuous aqueous phase, an organic phase containing at least one polymer including a polyether chain, optionally branched, bearing, per molecule, at least one terminal alkoxysilyl unit and at least two —OR groups borne by one or more silicon atoms, the dispersion containing further an emulsifier adapted to the formation of the dispersion and a polycondensation catalyst. The polymer preferably comprises at least two terminal alkoxysilyl units corresponding to the following formula (a): (R¹—O)ₙ(R²)mSi—, wherein n is 1, 2 or 3 and m is 0, 1 or 2, with n+m=3, the R¹ groups, mutually identical or different, the R² groups, mutually identical or different to R¹, are selected from the linear or branched C₁-C₈ alkyl groups. The invention also concerns a mixed dispersion containing a silylated polyether organic phase and a silicone-based organic phase.

The present invention relates to compositions based on silylated polyethers having alkoxysilyl units able to crosslink into an elastomer.

Silylated polyethers with alkoxysilyl units, commonly called MSP or MS polymers, are known from patent U.S. Pat. No. 3,971,751 which, in the presence of a condensation catalyst, can crosslink into an elastomer under the action of the humidity in the air and at ambient temperature. The elastomer possesses adhesivity and elasticity properties making it suitable for use in the field of sealing. Anhydrous compositions based on silylated polyethers are extremely sensitive to ambient humidity which calls for precautions to be taken during their production and storage. They are moreover difficult to apply since the cleaning of tools, surfaces etc requires the use of organic solvents. Among the other difficulties of these compositions is the release of alcohol, generally methanol.

The object of the present invention is to provide novel compositions that are capable of solving the problems of anhydrous compositions based on the silylated polyethers referred to above, while enabling elastic and adhesive polymers to be generated that can be used in particular in the field of mastics and the like used for example in jointing in building construction, the automobile industry and the electric household goods industry, or in the field of elastic coatings and paints.

In spite of their high reactivity to water, it has been unexpectedly proved that stable aqueous dispersions based on silylated polyethers can be obtained that fully satisfy the objectives of the invention. In particular, these dispersions are easily used in practice and cleaning can be carried out with water and, as an additional advantage, these dispersions can be diluted with water in order to reduce their viscosity.

The subject of the invention is therefore an aqueous dispersion capable of crosslinking by condensation into an elastomer by elimination of water in the presence of a polycondensation catalyst comprising, dispersed in a continuous aqueous phase, an organic phase containing at least one polymer having a polyether chain, possibly branched, carrying per molecule at least one alkoxysilyl end unit and at least two —OR groups carried by one or more silicon atoms (by definition, a silicon atom of an alkoxysilyl group), the dispersion furthermore containing an emulsifier capable of forming the dispersion. A condensation catalyst can be present in the organic phase or it can be added to an uncatalysed dispersion at any moment of manufacture or when the final dispersion is used.

The polymer preferably comprises:
at least two, and more preferably, at least three —OR groups carried by one or more (different) silicon atoms, and/or
at least two alkoxysilyl end units, it being understood that when the polymer is branched, the branching that is polyether by nature may carry an alkoxysilyl end unit.

In —OR, R can represent hydrogen or a linear or branched alkyl group with C1 to C8, better C1 to C3 and even better methyl. Generally the polyether polymer involved carries exclusively or mainly —OR groups in which R is an alkyl as described above. It is then possible to produce, within the organic phase, a certain degree of hydrolysis of alkoxy —OAlkyl groups, leading to hydroxy —OH groups. The case where R is hydrogen can then result in such hydrolysis, or indeed it has been possible to engage directly a polyether carrying —OH groups linked to terminal silicon atoms.

The alkoxysilyl unit or units which, by definition, carry said —OR groups, can in particular correspond to the following formula (a):

(R¹—O)ₙ(R²)ₘSi—

in which n is 1, 2 or 3 and m is 0, 1 or 2, with n+m=3; n is preferably 2 or 3; the R¹ groups that are identical to or different from each other, and R² that are identical to or different from each other and R¹, are chosen from linear or branched alkyl groups with C1 to C8, better with C1 to C3 and even better all representing methyl.

Generally, the units making up the polyether chain intended to form the organic phase are, or include, a polyoxyalkylene structure:

—R⁴—O—

in which the R⁴ groups, that are identical or different in the same chain, are divalent alkylene groups with C1 to C6, preferably with C3 or C4. Polymers can then be those with a single or several units, e.g. block copolymers and random polymers. In a preferred manner, the polyalkylene structure is substantially or exclusively of the R⁴═C3 or C4 type, even better polyoxypropylene (C3).

As has already been mentioned, the polyether can be branched, that is to say it can have one or more polyether side chains having the same general structure —R⁴—O—, which can possibly be terminated by an alkoxysilyl unit of formula (a).

When the end groups of polyether chains are not of the alkoxysilyl type, they can in particular be of the —CH₂OH type.

In the presence of —OH groups, resulting from in situ hydrolysis, or provided by the original polyether, it cannot be excluded that a certain degree of crosslinking between polyether chains is produced. The composition according to the invention can therefore carry in addition a certain proportion of polyether chains with hydroxysilyl units and chains crosslinked together by Si—O—Si bonds.

The dispersion can contain more than one type of these polymers.

Also, the polymer or polymers present can be moreover characterised by the fact that they possess a molecular weight of between 500 and 15,000, preferably between 3000 and 12,000.

It is preferable to use polymers that are liquid at ambient temperature (15-25° C.). Polymers can nevertheless be used of which the glass transition temperature is a little greater than ambient temperature, and it may be desirable then to liquefy them be mixing with a plasticising agent. As a plasticising agent, mention may be made of low-volatility solvents for polyethers (phthalates, alkylbenzenes, etc.)

The organic phase can also include a crosslinking agent, in particular a crosslinking silane. In particular such an agent is preferably present when the polymer only has two —OR groups per molecule. It can consist of a silane of formula

(R″)ᵤSiX₍₄₋ᵤ₎

in which the R″ groups, whether identical or different, are monovalent organic radicals, in particular methyl or vinyl, u is equal to 1 or 0, and Xs that are identical or different are organic condensable and/or hydrolysable groups chosen from:
OH;
alkoxy or alkenyloxy containing 1 to 10 carbon atoms;
aryloxy containing 6 to 13 carbon atoms;
acyloxy group containing 1 to 13 carbon atoms;
cetiminoxy group containing 1 to 8 carbon atoms;
amino- or amido-functional groups containing 1 to 6 carbon atoms bonded to silicon by an Si—N bond.

Such silanes are described in particular in U.S. Pat. No. 3,294,725; U.S. Pat. No. 4,584,341; U.S. Pat. No. 4,618,642; U.S. Pat. No. 4,608,412; U.S. Pat. No. 4,525,565; EP-A-387157; EP-A-340 120; EP-A-364 375; FR-A-1 248 826; FR-1 023477.

As examples, mention may be made of the following alkoxysilanes:

Si(OC₂H₅)₄; CH₃Si(OCH₃)₃; CH₃Si(OC₂H₅)₃; (C₂H₅O)₃Si(OCH₃);

### CH₂═CHSi(OCH₃)₃; CH₃(CH₂═CH)Si(OCH₃)₂; CH₂═CH(OC₂H₅)₃;

### CH₂═CHSi[ON═C(CH₃)C₂H₅]; CH₃ Si[ON═C(CH₃)₂]₃

### CH₃Si[—C(CH₃)═CH₂]₃;

methyltri(N-methylacetamidosilane); methyltris(cyclohexylaminosilane).

These silanes can be employed in quantities of the order of 0 to 10 parts by weight, preferably of the order of 0 to 5 parts by weight, per 100 parts of polyether.

Polycondensation catalysts are well known to persons skilled in the art and mention may be made of salts of carboxylic acid, alkoxides, chelates and halides of metals such as lead, zinc, zirconium, titanium, iron, barium, calcium, manganese, vanadium, bismuth, antimony, aluminium and particularly tin, and mixtures thereof or furthermore of nitrogen-containing compounds or amines.

Mention may more particularly be made of:
the reaction products of tin dicarboxylates and of ethyl polysilicate (U.S. Pat. No. 3,862,919)
the reaction products of dibutyltin diacetate and an alkyl silicate or an alkyltrialkoxysilane (BE-A-842 305)
tin bischelates (EP-A-147 323; 235-049).
diorganotin dicarboxylates (GB-A-1 289 900).

They can be employed in quantities than can extend to approximately 3 parts by weight, preferably close to 0.05 to 1 part by weight per 100 parts of polymer.

The catalyst can be dispersed in the organic phase before emulsification or then be added to the dispersion, possibly in the form of a catalyst emulsion.

The emulsifiers are known compounds. They can be liquid or solid and can be chosen from surfactants, hydrosoluble polymers such as polyvinyl alcohol and solid particles forming an emulsion known as a Pickering emulsion or the like.

The surfactants employed are preferably non-ionic. As examples, mention may be made of alkoxylated fatty acids, polyalkoxylated alkylphenols, polyalkoxylated or polyglycerolated fatty alcohols, polyalkoxylated fatty amides, alcohols and polyglycerol alphadiols, ethylene oxide-propylene oxide block polymers, etc. as well as alkylglucosides, alkylpolyglucosides, sucroethers, sucroesters, sucroglycerides, sorbitan esters etc, and ethoxylated compounds of these sugar derivatives, etc;

Anionic surfactants can be chosen from the alkylbenzene sulfonates, alkylsulfates, alkylether sulfates, alkylarylether sulfonates, dioctylsulfosuccinates, of alkali metals etc.

The surfactant or mixture of surfactants used can have an HLB of the order of 11 to 15, in particular when the surfactant is non-ionic.

The weight ratio of water/water+surfactant(s) is a function of the viscosity of the polymer phase and of the nature of the surfactant (or mixture of surfactants). This ratio is for example of the order of 20/100 to 70/100, preferably of the order of 25/100 to 60/100.

The dispersion may contain a filler, preferably in the aqueous phase. This can consist of a reinforcing filler, a semi-reinforcing filler, or an extending filler or a mixture of at least two types. Among reinforcing fillers, mention may first of all be made of siliceous fillers such as colloidal silica and precipitated silica. Examples of semi-reinforcing or extending fillers are natural extending calcium carbonate, semi-reinforcing industrial carbonates, diatomaceous earths, ground quartz, hydrated alumina, magnesium hydroxide, carbon black, titanium dioxide, aluminium oxide, vermiculite, zinc oxide, mica, talc, iron oxide, barium sulfate, or calcium hydroxide. The particles size of these fillers is generally of the order of 0.001 to 300 μm.

In preferred embodiments, a reinforcing filler, in particular colloidal silica, and/or a semi-reinforcing filler, in particular based on a carbonate, will be present.

Industrial carbonates can be used as semi-reinforcing fillers. Precipitated carbonates, e.g. precipitated calcium carbonate, may be mentioned. Under these conditions, access may be had to carbonates of which the mean particle size is generally less than 1 μm, in particular less than or equal to 0.5 μm. These precipitated carbonates can then have a high BET specific surface area, greater than 5 m²/g. Such carbonates are preferably employed having a mean particle size less than or equal to 0.1 μm, more preferably between 0.01 and 0.1 μm, and preferably having a BET specific surface area extending from 10 to 70 m²/g, preferably from 15 to 30 m²/g. In a particularly preferred manner, as is know for improving the dispersability of carbonates in a hydrophobic medium, the carbonates according to the invention are treated in particular with carboxylic fatty acids, as for example stearic acid.

Various types of amorphous silica can be used as reinforcing fillers, namely precipitated silicas and colloidal silicas. It is of course possible to use cuts of various silicas. Their BET specific surface area is generally greater than 40 m²/g and preferably between 100 and 300 m²/g.

A dispersing agent for fillers can be provided, as for example alkali metal polyacrylates with a molecular weight less than 5,000, or inorganic phosphates etc in quantities that can extend up to 10% by weight of the final aqueous dispersion.

The dispersion can also include at least one adhesion promoter, preferably chosen from organosiliceous compounds, whether aminated or not, preferably silanes, whether aminated or not, carrying at the same time:
(1) one or more hydrolysable groups bonded to the silicon atom and
(2) one or more organic groups having radicals chosen from the group of aminated (or diaminated), (meth)acrylate, epoxy, alkenyl (typically from 2 to 6 C) and/or alkyl radicals (typically from 1 to 8 C).
   As examples, one of the following silanes can be used, or a mixture of at least two of these:
   3-aminopropyltriethoxysilane,
   beta-aminoethyl-gamma-aminopropyltrimethoxysilane
   beta-aminoethyl-gamma-aminopropylmethyldimethoxysilane
   3-aminopropyltrimethoxysilane,
   vinyltrimethoxysilane,
   3-glycidyloxypropyl-trimethoxysilane,
   3-methacryloxypropyltrimethoxysilane,
   propyltrimethoxysilane,
   methyltrimethoxysilane,
   ethyltrimethoxysilane,
   vinyltriethoxysilane,
   3-aminopropylmethyldimethoxysilane,
   3-aminopropylmethyldiethoxysilane,
   methyltriethoxysilane,
   propyltriethoxysilane,
   tetraethoxysilane,
   tetrapropoxysilane,
   tetraisopropoxysilane,
      or hydrolysis and condensation products, such as polyorganosiloxane oligomers containing such organic groups in an amount greater than 20%.

The adhesion promoter will be distributed between the aqueous and organic phases according to its solubility parameters.

Among preferred modes of embodiment, mention will be made of aminated silanes, such as aminopropyltriethoxysilane, and aqueous silanes sold by Degussa under the name Hydrosyl® HS.

It is also possible to use a silicate as an adhesion promoter carrying one or more hydrolysable groups, particularly alkali groups, typically with 1 to 8 C. Mention may be made of propyl silicates, isopropyl silicates and ethyl silicates. Silicates may or may not be polycondensed.

For the adhesion promoter, as for the condensation catalyst, it is possible to consider making use of a bi-component product, with on the one hand the dispersion of the organic phase containing the polyether, and on the other hand a catalyst and/or promoter preparation, e.g. in a dispersed or emulsified form, the two parts being capable of being mixed and of enabling the elastomer to be produced during drying.

Dispersions according to the invention can be defined as those able to crosslink by condensation into an elastomer by elimination of water in the presence of a polycondensation catalyst, and that are capable of being obtained by dispersing, in a continuous aqueous phase, an organic phase containing at least one polymer having a polyether chain, possibly branched, carrying at least one alkoxysilyl end unit and at least two —OR groups carried by a silicon atom, and possibly a polycondensation catalyst, the dispersion furthermore containing an emulsifier suitable for forming the dispersion. It has already been mentioned above that the exact composition may change with time, with hydrolysis reactions of alkoxy —Oalkyl groups into hydroxy groups and possibly with grafts between chains. Dispersions that can be obtained in this way thus include —Oalkyl and/or —OH groups in various proportions and possibly polyether chains that are more or less crosslinked together. A condensation catalyst can be present in the organic phase or it can be added to the uncatalysed dispersion at any moment of the manufacture, or when the final dispersion is used.

According to one feature of the invention, the dispersion is such as that obtained after partial or total hydrolysis of —Oalkyl groups into —OH and elimination, e.g. devolatilisation, of all or part of the alcohol, e.g. methanol, produced. A dispersion is obtained with a small alcohol, e.g. methanol, content and consequently will liberate very little alcohol during drying.

“Oil-in-water” emulsification of the organic phase can be carried out by introducing this phase into a mixture of water+surfactant(s) or preferably by introducing water into a mixture of the organic phase and surfactant(s) and blending in blenders of the extruder type with a single or multiple screws, planetary turbine blenders, static blenders, blenders with paddles, propellers, arms etc at a temperature of the order of 10 to 50° C.

The dry matter of dispersions according to the invention can represent from 40 to 90%, preferably between 70 to 87% by weight of the total dispersion. For coating applications, the dry matter is advantageously between 70 and 80%. For applications of the mastic or cold adhesive type, the dry matter is advantageously greater than 80%.

As already mentioned, a certain degree of hydrolysis can be allowed to occur, followed by elimination, e.g. by devolatilisation, of the alcohol produced by this hydrolysis.

The dispersion according to the invention can additionally include a second organic phase containing a silicone composition of the type of those normally used in aqueous dispersions based on silicone oils that can crosslink, by elimination of water, into an elastomer that can be used for building construction, the automobile industry and the electric household goods industry, in particular in the form of sealants, paints etc. The complex dispersion according to the invention can simply result from mixing a first dispersion of polyether polymer and a second dispersion of a silicone composition. It can also result from the simultaneous or successive emulsification of two organic phases. It will therefore be possible to use, within the scope of this invention, normal silicone compositions or silicone dispersions, for example those described in FR-A-2 697 021 and FR-A-2 780 067. These compositions contain a reactive silicone oil, that is to say one carrying at least two condensable functional groups, chosen for example from:
OH group (preferred mode of embodiment);
alkoxy or alkenyloxy group containing 1 to 10 carbon atoms;
aryloxy group containing 6 to 13 carbon atoms;
acyloxy group containing 1 to 13 carbon atoms;
cetiminoxy group containing 1 to 8 carbon atoms;
amino- or amido-functional group containing 1 to 6 carbon atoms, bonded to silicon by an Si—N bond.

Preferably, a hydroxylated silicone oil is chosen as a base. Such an oil can be an α,ω-hydroxylated polydiorganosiloxane (POS) of formula:

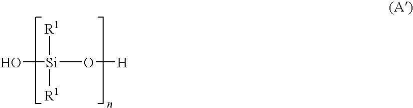

the R¹ groups, that are identical or different, each represents a monovalent hydrocarbon radical with C₁ to C₁₃, that is saturated or not and is aliphatic, cyclanic or aromatic;
n has a value sufficient to give the POS A′ a dynamic viscosity at 25° C. extending from 500 to 1,000,000 mPa·s

The silicone organic phase can contain the usual additives and, first of all, a polycondensation catalyst chosen from those described above for the polyether phase. It will preferably consist of the same catalyst. The quantities involved will also be of the same order of magnitude.

As regards the emulsifier, this will also correspond to the definition given for the polyether phase, and will preferably be the same. The quantities involved will also be of the same order of magnitude.

A filler can also be provided. Preferably, the silicone phase contains a reinforcing, semi-reinforcing or extending filler or a mixture of at least two types. These fillers are generally chosen from those described above for the polyether phase. Colloidal silicas and those based on carbonates are the normally preferred ones. The quantities involved will also be of the same order of magnitude.

The silicone phase can also contain:
a crosslinking agent and/or
a crosslinking silane, e.g. as described above for the polymer dispersion
a hydroxylated or alkoxylated silicone resin,
a plasticiser for the organic phase, as for example polydimethylsiloxane oils with a viscosity of the order of 300 to 10,000 mPa·s, dioctylphthalates, dialkylbenzenes etc, possibly in an aqueous emulsion in quantities of 0 to 70 parts by weight to 100 parts by weight of oil (A′); and/or
a dispersing agent for fillers for the aqueous phase, as for example alkali metal polyacrylates with a molecular weight less than 5000, inorganic phosphates etc in quantities that can extend up to 10% by weight of the final aqueous dispersion.

When a silicone phase is present in the dispersion, the values for dry matter mentioned above, which remain valid, are the sum of the dry matter of the polyether phase and that of the silicone phase.

Generally, the ratio of silicone phase to polyether phase in the dispersion will lie between 0.1 and 10, preferably between 0.5 and 5.

In the present application, the viscosity of the oils is a Newtonian dynamic viscosity at 25° C. measured with the aid of a Brookfield viscometer according to details given by the AFNOR NFT 76102 standard of May 1982.

The BET specific surface area is determined according to the Brunauer, Emmet and Teller method described in “The Journal of American Chemical Society, vol. 80, page 309 (1938)” corresponding to Afnor NFT 45007 standard of November 1987.

The invention also relates to elastomers that can be obtained by crosslinking a dispersion according to the invention, by condensation by elimination of water, in the presence of a polycondensation catalyst.

The subject of the invention is also a kit comprising separately under the same package, on the one hand an aqueous dispersion according to the invention, with no catalyst, and on the other hand a preparation of the condensation catalyst of the invention, for example in the form of an emulsion, these two parts being intended to be blended before use.

The present invention will now be explained in greater detail with the aid of embodiments taken as non-limiting examples.

The preparation of a mastic comprises two steps: emulsification of the polyether oil or MSP oil in water (example 1) followed by the formulation of the final product (examples 2, 3 and 4).

### EXAMPLE 1

### Preparation of a Concentrated Emulsion (MSP in Water, Emulsification Step

Emulsification was carried out in an apparatus with scraper blades and a central stirrer of the butterfly type (here a Euromélange batch mixer). The following were loaded into a 10-litre jacketed vessel
MSP oil S303H®: (Kaneka): 3000 g

The MSP polymer oil is an oil with a polypropoxy chain at its silylated ends, with methoxy functional groups, of the general average formula:

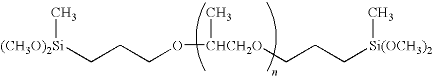

Rhodasurf® ROX surfactant from Rhodia Chimie (ethoxylated isotridecyl alcohol, having an average of 8 CH₂CH₂O units, with 85% active material in water): 450 g
Demineralised water: 525 g
Stirring was carried out: —with the scraper at 60 rpm
   with the central butterfly at 400 rpm

The mixture was cooled by water circulation in the jacket for all the duration of the manipulation, so as not exceed 40° C. After approximately 2 minutes, a concentrated oil-in-water emulsion was obtained by phase inversion. The mixture assumed a gel-like appearance and acquired a pourability threshold. The product no longer flowed, as did the starting oil. In order to verify that phase inversion had indeed taken place, a small sample of the mixture was taken and the latter placed in a little demineralised water. Dissolution of the product in water was observed, and emulsification had therefore succeeded (an oil-in-water emulsion was obtained).

A supplementary 3000 g of MSP oil were then slowly (within 5 min while stirring) poured in. After this addition, stirring was carried out for a further 5 min (still scraping at 60 rpm and with the butterfly at 400 rpm). The particle size of the emulsion was then measured with the aid of a Coulter particle size analyser, LS 130 and a mean particle size of 0.4 μm was measured. The concentrated emulsion was packaged in a 10 litre sealed container in order to prevent water loss which would harm the stability of the product. The dry extract of the emulsion obtained was 91%.

### EXAMPLE 1a

### Preparation of a Concentrated Emulsion (Silicone in Water), Emulsification Step

Emulsification was carried out in an apparatus with scraper blades and a central stirrer of the butterfly type (here a Euromélange batch mixer). The following were loaded into a 10-litre jacketed vessel:
α,ω-hydroxylated polydimethylsiloxane oil with a viscosity of approximately 135,000 mPa·s: 2000 g
Surfactant (the same as in example 1): 142 g
Demineralised water: 66 g.
Stirring was carried out: —with the scraper at 60 rpm
   with the central butterfly at 400 rpm

The mixture was cooled by water circulation in the jacket for all the duration of the manipulation, so as not to exceed 40° C. After approximately 2 minutes, a concentrated oil-in-water emulsion was obtained by phase inversion. The mixture assumed a gel-like appearance and acquired a pourability threshold. The product no longer flowed as did the starting oil. In order to verify that phase inversion had indeed taken place, a small sample of the mixture was taken and the latter placed in a little demineralised water. Dissolution of the product in water was observed, and emulsification had therefore succeeded (a silicone oil-in-water emulsion was obtained). The final dry extract of the product was 96% and the mean particle size was 0.4 μm.

### EXAMPLE 2

### Formulation of an MSP Mastic in an Emulsion

The constituents of the following formula were added successively to a 2-litre blender, with very slow stirring over all the manipulation. The mixer used was a Lab Max® from Molteni, the speed of rotation of the tools was 20 rpm and the scraper was activated. Cold water was circulated through the jacket during all the duration of the manipulation.

| | | MSP mastic in |
|---|---|---|
| | | emulsion, only |
| | MSP mastic | lightly |
| Component | in emulsion | reinforced |
| Concentrated MSP emulsion (ex. 1) | 465 | 465 |
| Water | 88 | 77 |
| Na polyacrylate dispersant Coatex ® P50 | 8 | 8 |
| Treated carbonate Socal ® 312, | 120 | 60 |
| specific surface area 20 m²/g (Solvay) | | |
| Carbonate slurry Omyacoat ®, 72% | 200 | 100 |
| carbonate in water (Omya) | | |
| Hydrolysed aminopropyltriethoxysilane | 26 | 26 |
| oligomerised in solution, Silquest | | |
| VS 142 (OSI) | | |
| Dioctyltin dilaurate in emulsion | 2 | 2 |
| (emulsion from Rhodia Chimie) | | |
| TOTAL | 909 g | 738 g |
| FINAL DRY EXTRACT | 77.5% | 77.5% |

Slow stirring was maintained until the mixture was perfectly homogeneous. Degassing was then carried out under a vacuum of 50 mbar for approximately 20 minutes until occluded air and volatiles had been removed. The product was then packaged in 310 ml polyethylene cartridges. The residual quantity of methanol and methoxy groups was lower than in the starting MSP, taking into account the hydrolysis of methoxies in the presence of water and the devolatilisation conditions used.

### EXAMPLE 3

### Formulation of a Hybrid MSP/Silicone Mastic in Emulsion

The procedure was the same as for example 2.

The constituents of the following formula were added successively to a 2-litre blender, with very slow stirring over all the manipulation. The mixer used was a Lab Maxi from Molteni, the speed of rotation of the tools was 20 rpm and the scraper was activated. Cold water was circulated through the jacket during all the duration of the manipulation.

| | Hybrid mastic |
|---|---|
| Component | in emulsion |
| Concentrated MSP emulsion (ex. 1) | 230 |
| Concentrated silicone emulsion (ex. 1a) | 230 |
| Silicone resin* | 2 |
| Water | 200 |
| Coatex ® P50 dispersant | 8 |
| Socal ® 312 treated carbonate | 120 |
| Carbonate slurry Omyacoat ® | 175 |
| Silane in solution VS 142 | 26 |
| Dioctyltin dilaurate in emulsion | 2 |
| TOTAL | 1018 g |
| FINAL DRY EXTRACT | 70.0% |

*Description of the resin: it consists of a silicone resin made up of MeSiO_{3/2} units (approximately 68% molar), Me₂SiO (approximately 21%), and Me₃SiO_{1/2} (approximately 10%), Mn = 1680 g/mole, R/Si ratio = 1.4, with 0.5% OH (by weight) and with a viscosity of approximately 1000 mPa · s.

Slow stirring was maintained until the mixture was perfectly homogeneous. Degassing was then carried out under a vacuum of 50 mbar for approximately 20 minutes until occluded air and volatiles had been removed. The product was then packaged in 310 ml polyethylene cartridges.

### EXAMPLE 4

### Addition of an MSP Emulsion to a Silicone Mastic in Emulsion (Rhodalis' 4000 or Revetosil® P40

Rhodalis® 4000 (commercial reference Revetosil® 4000) is a fluid formulation used for coating applications, the main constituent of which is a silicone emulsion. By associating this product with an MSP emulsion (example 1) the properties of the final material were modified.

The MSP emulsion could be added directly to Rhodalis® 4000, with slow stirring (20 rpm). 50 g of the MSP emulsion of example 1 were added to 100 g of Rhodalis® 4000.

### EXAMPLE 5

### Results

These were as follows:

DCH 81-2: MSP mastic in emulsion (example 2)
DCH 81-4: hybrid MSP/silicone mastic in emulsion (example 3)
DCH 81-5: MSP mastic in emulsion, only lightly reinforced (example 2).

### Qualitative Adhesion Tests

In order to perform qualitative adhesion tests, a strip of the product was deposited on previously cleaned substrates. After a crosslinking time of 7 days (at 23° C. and 50% RH=residual humidity) manual peeling was carried out after having started detachment at the substrate/mastic interface. The results were expressed as a function of the type of rupture of the strip of product:

AR if there was an adhesive rupture (the strip became detached from the substrate)
AR+, rupture has an adhesive tendency but needs a force to be applied in order to detach the strip
AR++, rupture has an adhesive tendency but needs a large force to be applied in order to detach the strip
CR if there is a cohesive-type rupture (the strip breaks with the application of a very large force, without being detached, even partially, from the substrate). In this case, adhesion to the substrate is optimal.

| | DCH 81-2 | DCH 81-4 | DCH 81-5 |
|---|---|---|---|
| | Pure MSP | MSP/silicone | Pure MSP |
| Substrate | DE 77.5% | DE 70% | DE 77.5% |
| Glass | RA+ | RA+ | RA |
| Wood (pine) | RC | RA+ | RA+ |
| PVC | RC | RA+ | RA++ |
| Anodised aluminium | RC | RC | RC |
| Filled PMMA | RA++ | RA+ | RA+ |

DE = dry extract

### Following the Shore A Hardness

The Shore A hardness was measured with the aid of a Zwick® durometer. It characterised the amount of penetration of a calibrated point into a stack of three films 2 mm thick, crosslinked at 23° C. and 50% relative humidity. The Shore A hardness (SAH) of the film characterised the advance of crosslinking:

| Shore A hardness | DCH 81-2 | DCH 81-4 | DCH 81-5 |
|---|---|---|---|
| SAH 1 day | 31 | 8 | 22 |
| SAH 2 days | 38 | 11 | 26 |
| SAH 3 days | 39 | — | — |
| SAH 4 days | — | — | — |
| SAH 5 days | — | 17 | 28 |
| SAH 6 days | 39 | — | — |
| SAH 7 days | 40 | 18 | 28 |

### Mechanical Properties of Mastics in Emulsion

The mechanical properties were measured with the aid of an Instron® dynamometer on H2 specimens cut with a hollow punch from the elastomer obtained by drying a 2 mm thick film for 7 days. The modulus at 100% elongation was noted as well as the breaking strength.

| Mechanical properties | DCH 81-2 | DCH 81-4 | DCH 81-5 |
|---|---|---|---|
| 100% modulus (MPa) | — | 0.32 | 0.56 |
| Elongation at break (%) | 78 | 594 | 109 |
| Breaking strength (MPa) | 0.68 | 1.04 | 0.58 |

| | | Rhodalis 4000 + |
|---|---|---|
| Mechanical properties | Rhodalis 4000 | MSP emulsion (40 g + 20 g) |
| 100% modulus (MPa) | 0.5 | 0.25 |
| Elongation at break (%) | 423 | 663 |
| Breaking strength (MPa) | 0.79 | 0.92 |

It was found that:
these emulsions can be diluted with water and it is possible to clean tools with water;
the MSP polymer emulsions have a very low toxicity risk in the sense that they liberate less methanol than conventional anhydrous MSP mastics;
hybrid silicone/MSP compositions in emulsion lead to a final elastomer obtained after drying that is macroscopically homogeneous in spite of the fact that the 2 polymers are incompatible (immiscible) and that the MSP emulsion enables the ultimate properties of the aqueous silicone mastic to be improved (elongation and breaking strength).

It should be understood that the invention defined by the appended claims is not limited to the particular embodiments indicated in the description above, but encompasses variants that do not fall outside the scope or spirit of the present invention.

1-27. (canceled)

28. An aqueous dispersion that crosslinks by condensation into an elastomer by elimination of water in the presence of a polycondensation catalyst, comprising, dispersed in a continuous aqueous phase, an organic phase comprising at least one polymer having a polyether chain, optionally branched, carrying per molecule at least one alkoxysilyl end unit and at least two —OR groups carried by one or more silicon atoms, the dispersion also containing an emulsifier suitable for the formation of the dispersion and a polycondensation catalyst.

29. The aqueous dispersion as defined by claim 28, in which the polymer has at least two or at least three —OR groups carried by one or more silicon atoms, and/or at least two alkoxysilyl end units.

30. The aqueous dispersion as defined by claim 28, in which the polymer has at least one or at least two alkoxysilyl end units corresponding to the following formula (a):
(R¹—O)ₙ(R²)ₘSi—
in which n is 1, 2 or 3 and m is 0, 1 or 2, with n+m=3; the R¹ groups that are identical to or different from each other, and R² that are identical to or different from each other and R¹, are each a linear or branched alkyl radical with C1 to C8.

31. The aqueous dispersion as defined by claim 30, in which n is 2 or 3.

32. The aqueous dispersion as defined by claim 28, in which the units constituting the polyether chain are, or include, a polyoxyalkylene structure:
—R⁴—O—
in which the R⁴ groups, that are identical or different, are divalent C₁ to C₆ alkylene radicals.

33. The aqueous dispersion as defined by claim 32, in which the R⁴ groups are divalent C₃ or C₄ alkylene radicals.

34. The aqueous dispersion as defined by claim 32, in which the polyether has one or more polyether side chains having the same general structure —R⁴—O— terminated by an alkoxysilyl unit corresponding to the following formula (a).
(R¹—O)ₙ(R²)ₘSi—
which n is 1, 2 or 3 and m is 0, 1 or 2, with n+m=3; the R¹ groups that are identical to or different from each other, and R² that are identical to or different from each other and R¹, are each a linear or branched C₁ to C₈ alkyl radical.

35. The aqueous dispersion as defined by claim 28, containing a polycondensation catalyst in the organic phase.

36. The aqueous dispersion as defined by claim 28, in which the aqueous phase contains a filler.

37. The aqueous dispersion as defined by claim 36, containing a colloidal silica or a semi-reinforcing filler based on a carbonate.

38. The aqueous dispersion as defined by claim 28, containing an adhesion promoter.

39. The aqueous dispersion as defined by claim 38, comprising as an adhesion promoter an organosiliceous compound, aminated or not, carrying at the same time:
(1) one or more hydrolyzable groups bonded to the silicon atom, and
(2) one or more organic groups having radicals selected from the group consisting of aminated (or diaminated), (meth)acrylate, epoxy, alkenyl and/or alkyl radicals.

40. The aqueous dispersion as defined by claim 39, in which the organosiliceous compound is a silane.

41. The aqueous dispersion as defined by claim 40, in which the silane is:
3-aminopropyltriethoxysilane,
beta-aminoethyl-gamma-aminopropyltrimethoxysilane beta-aminoethyl-gamma-aminopropylmethyldimethoxysilane
3-aminopropyltrimethoxysilane,
vinyltrimethoxysilane,
3-glycidyloxypropyl-trimethoxysilane,
3-methacryloxypropyltrimethoxysilane,
propyltrimethoxysilane,
methyltrimethoxysilane,
ethyltrimethoxysilane,
vinyltriethoxysilane,
3-aminopropylmethyldimethoxysilane,
3-aminopropylmethyldiethoxysilane,
methyltriethoxysilane,
propyltriethoxysilane,
tetraethoxysilane,
tetrapropoxysilane,
tetraisopropoxysilane,
or hydrolysis and condensation products, or mixtures thereof.

42. The aqueous dispersion as defined by claim 28, containing a crosslinking silane.

43. The aqueous dispersion as defined by claim 42, in which the crosslinking silane corresponds to the formula:
(R″)ᵤSiX₍₄₋ᵤ₎
in which the R″ groups, whether identical or different, are monovalent organic radicals, u is equal to 1 or 0, the Xs, identical or different, are organic condensable and/or hydrolyzable groups selected from among:
OH;
alkoxy or alkenyloxy containing 1 to 10 carbon atoms aryloxy containing 6 to 13 carbon atoms;
acyloxy group containing 1 to 13 carbon atoms;
cetimonoxy group containing 1 to 8 carbon atoms;
amino- or amido-functional group containing 1 to 6 carbon atoms bonded to silicon by an Si—N bond.

44. The aqueous dispersion as defined by claim 43, containing, as the crosslinking silane:
Si(OC₂H₅)₄; CH₃Si(OCH₃)₃; CH₃Si(OC₂H₅)₃; (C₂H₅O)₃Si(OCH₃);
CH₂═CHSi(OCH₃)₃; CH₃(CH₂═CH)Si(OCH₃)₂; CH₂═CH(OC₂H₅)₃;
CH₂═CHSi[ON═C(CH₃)C₂H₅]; CH₃Si[ON═C(CH₃)₂]₃ CH₃Si[—C(CH₃)═CH₂]₃;
methyltri(N-methylacetamidosilane); or methyltris(cyclohexylaminosilane).

45. The aqueous dispersion as defined by claim 28, additionally having a second dispersed organic phase containing a silicone oil.

46. The aqueous dispersion as defined by claim 45, in which the second organic phase is of the type crosslinking by polycondensation.

47. The aqueous dispersion as defined by claim 45, in which this second dispersed organic phase contains a reactive silicone oil carrying at least two condensable functional groups.

48. The aqueous dispersion as defined by claim 47, in which the condensable functional groups are selected from among:
OH group;
alkoxy or alkenyloxy group containing 1 to 10 carbon atoms;
aryloxy group containing 6 to 13 carbon atoms;
acyloxy group containing 1 to 13 carbon atoms;
cetiminoxy group containing 1 to 8 carbon atoms;
amino- or amido-functional group containing 1 to 6 carbon atoms, bonded to silicon by an Si—N bond.

49. The aqueous dispersion as defined by claim 47, in which the second organic phase comprises
an α,ω-hydroxylated polydiorganosiloxane (POS) of formula: 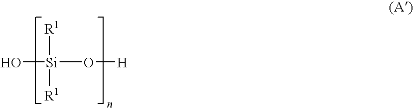
the R¹ groups, that are identical or different, are each a monovalent C₁ to C₁₃ hydrocarbon radical, that is saturated or not, substituted or unsubstituted, and is aliphatic, cyclanic or aromatic;
n has a value sufficient to give the POS A′ a dynamic viscosity at 25° C. extending from 500 to 1,000,000 mPa·s.

50. The aqueous dispersion as defined by claim 45, in which the second organic phase comprises a polycondensation catalyst, a filler, a crosslinking agent, a crosslinking silane, a hydroxylated or alkoxylated silicone resin, a plasticizer, an agent for dispersing fillers, or a mixture of at least two of such additives.

51. The aqueous dispersion as defined by claim 45, in which the ratio of silicone phase to polyether phase in the dispersion ranges from 0.1 to 10.

52. The aqueous dispersion as defined by claim 51, in which said ratio ranges from 0.5 to 5.

53. An elastomer obtained by crosslinking in the presence of a polycondensation catalyst, and by elimination of water, of a dispersion as defined by claim 28.

54. A kit comprising, separately in the same package, an aqueous dispersion as defined by claim 28, with no polycondensation catalyst, and a preparation of a polycondensation catalyst.
